(19) United States
(12) Patent Application Publication
(10) Pub. No.: US 2011/0018514 A1
(43) Pub. Date: Jan. 27, 2011

(54) Dual-mode buck switching regulator and control circuit therefor

(75) Inventors: An-Tung Chen, Pingzhen City (TW); Li-Wen Fang, Chupei City (TW)

Correspondence Address: TUNG & ASSOCIATES / RANDY W. TUNG, ESQ., 838 W. LONG LAKE RD., SUITE 120, BLOOMFIELD HILLS, MI, 48302, US

(73) Assignee: Richtek Technology Corporation, R.O.C.

(21) Appl. No.: 12/658,692

(22) Filed: Feb. 12, 2010

(30) Foreign Application Priority Data
Jul. 22, 2009 (TW) 098213432

(51) Int. Cl. G05F 1/10

(52) U.S. Cl. 323/283; 323/282

(57) ABSTRACT

The present invention discloses a dual-mode buck switching regulator, comprising: a first power transistor having an end coupled to an input voltage and another end coupled to a common node; an inductor having an end coupled to the common node and another end coupled to the input voltage; a second power transistor having an end coupled to ground; a diode having an end coupled to ground; and a control circuit generating a first and a second switch control signals for controlling operations of the first and the second power transistors according to a feedback signal, and generating a mode selection signal according a mode control signal to select a synchronous or an asynchronous mode, wherein the second power transistor has another end which is coupled to the common node in the synchronous mode, and the diode has another end which is coupled to the common node in the asynchronous mode, and in the asynchronous mode: the another end of the second power transistor is not coupled to the common mode, or the second power transistor maintains off. The present invention also relates to a control circuit of the dual-mode buck switching regulator.

### BACKGROUND OF THE INVENTION

1. Field of Invention

The present invention relates to a dual-mode buck switching regulator capable of switching between a synchronous mode and an asynchronous mode and a control circuit therefor.

2. Description of Related Art

FIGS. 1 and 2 show prior art synchronous buck switching regulator 1 and asynchronous buck switching regulator 2, respectively. In FIG. 1, a first and a second power transistors Q1 and Q2 are connected to a common node. The first power transistor Q1 is connected between an input voltage Vin and the common node; the second power transistor Q2 is connected between the common node and ground; and the inductor L is connected between the common node and the output voltage Vout. The control circuit 10 generates switch control signals to control operations of the power transistors Q1 and Q2 according to a feedback signal FB obtained from the output voltage Vout, such that power is transmitted from the input voltage Vin to the output voltage Vout. The first and second power transistors Q1 and Q2 switch synchronously, and therefore the circuit is referred to as a synchronous buck switching regulator. In FIG. 2, the second power transistor Q2 is replaced by a diode D, so only the first power transistor Q1 operates in the circuit; hence, the circuit is referred to as an asynchronous buck switching regulator.

The foregoing prior art synchronous buck switching regulator has better efficiency in heavy load condition (i.e., when a higher load current is required), but it is less efficient in light load or no load condition. On the contrary, the asynchronous buck switching regulator has better efficiency than the synchronous buck switching regulator in the light load or no load condition because there is no negative current, but it is less efficient in the heavy load condition because the diode has a higher voltage drop.

As such, it is required to provide a circuit combining both advantages to enhance the entire efficiency.

### SUMMARY OF THE INVENTION

In view of the foregoing, an objective of the present invention is to provide a dual-mode buck switching regulator capable of operating in a synchronous mode and an asynchronous mode.

Another objective of the present invention is to provide a control circuit for the foregoing dual-mode buck switching regulator.

According to the foregoing objectives, in one perspective of the present invention, it provides a dual-mode buck switching regulator comprising: a first power transistor having an end coupled to an input voltage and another end coupled to a common node; an inductor having an end coupled to the common node and another end coupled to the output voltage; a second power transistor having an end coupled to ground; a diode having an end coupled to ground; and a control circuit generating a first and a second switch control signals for controlling operations of the first and the second power transistors according to a feedback signal, and generating a mode selection signal according to a mode control signal to select a synchronous or an asynchronous mode, wherein the second power transistor has another end which is coupled to the common node in the synchronous mode, and the diode has another end which is coupled to the common node in the asynchronous mode, and in the asynchronous mode: (1) the another end of the second power transistor is not coupled to the common mode, or (2) the second power transistor maintains off.

In another perspective of the present invention, it provides a control circuit for a dual-mode buck switching regulator, comprising: an error amplifier comparing a feedback signal with a first reference signal to generate an error amplified signal; a PWM generator generating a first and a second PWM signals according to the error amplified signal; and a mode selection circuit generating a mode selection signal according to a mode control signal to determine whether the dual-mode buck switching regulator enters a synchronous mode or an asynchronous mode.

In one embodiment, the foregoing dual-mode buck switching regulator or the control circuit therefor further comprises a switch circuit selectively coupling the another end of the second power transistor or the another end of the diode to the common node according to the mode selection signal. Or, the another end of the diode is always coupled to the common node, and the foregoing dual-mode buck switching regulator or the control circuit therefor further comprises a switch circuit selectively coupling the another end of the second power transistor to the common node according to the mode selection signal. Or, the another end of the diode is always coupled to the common node, and the second power transistor maintains off in the asynchronous mode.

In one embodiment, the foregoing control circuit for the dual-mode buck switching regulator further comprises a logic gate performing logic operation on the second PWM signal generated by the PWM generator and the mode selection signal to generate a second switch control signal, such that the second power transistor maintains off when the mode selection signal selects the asynchronous mode.

For purpose of transmitting sufficient power within one on-time of the first power transistor, in one embodiment, the foregoing control circuit for the dual-mode buck switching regulator further comprises a minimum on-time circuit generating a minimum on-time when the mode selection signal selects the asynchronous mode, such that the first power transistor operates according to the minimum on-time.

In one embodiment of the foregoing control circuit for the dual-mode buck switching regulator, the mode selection circuit includes a comparator comparing the mode control signal with a second reference signal to generate the mode selection signal. The mode control signal can be any signal capable of determining a load condition.

The objectives, technical details, features, and effects of the present invention will be better understood with regard to the detailed description of the embodiments below, with reference to the drawings.

### BRIEF DESCRIPTION OF THE DRAWINGS

FIG. 1 is a schematic circuit diagram showing a structure of a prior art synchronous buck switching regulator.

FIG. 2 is a schematic circuit diagram showing a structure of a prior art asynchronous buck switching regulator.

FIGS. 3-5 are schematic circuit diagrams showing three embodiments of a dual-mode buck switching regulator of the present invention.

FIG. 6 shows one embodiment of a control circuit 30.

FIG. 7 illustrates, by way of example, how a mode selection circuit 303 generates a mode selection signal 33.

FIG. 8 illustrates another embodiment of the control circuit 30.

FIGS. 9 and 10 illustrate, by way of example, that the switch SW2 (SW1), diode D, and power transistors Q1 and Q2 can be integrated into the control circuit 30 (30′) as an integrated circuit.

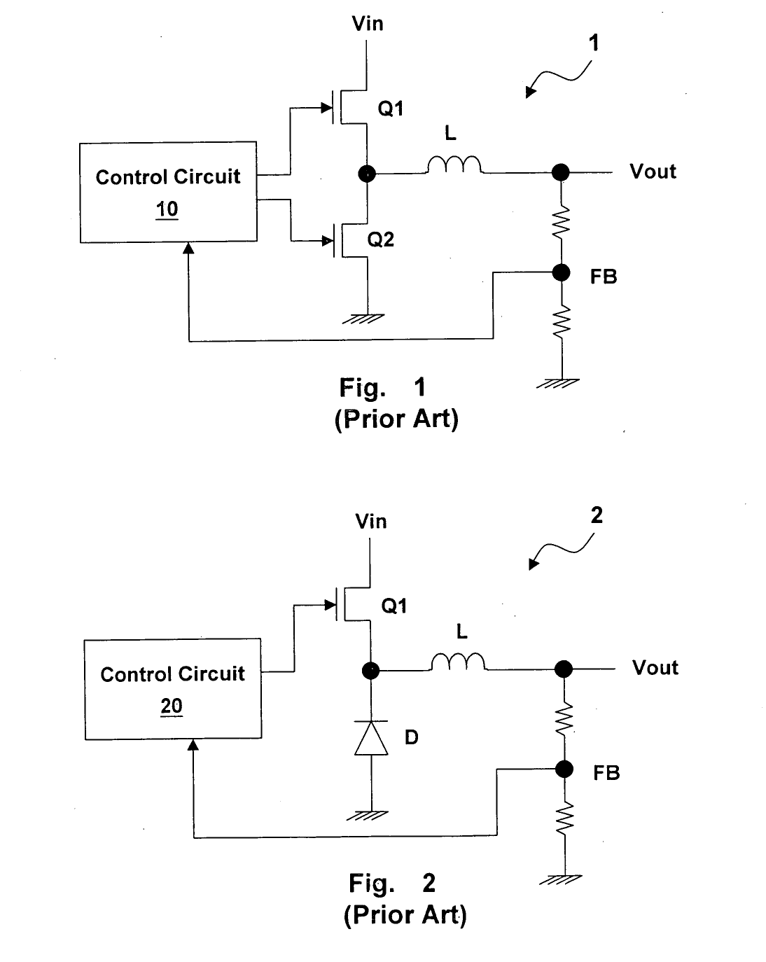

### DESCRIPTION OF THE PREFERRED EMBODIMENTS

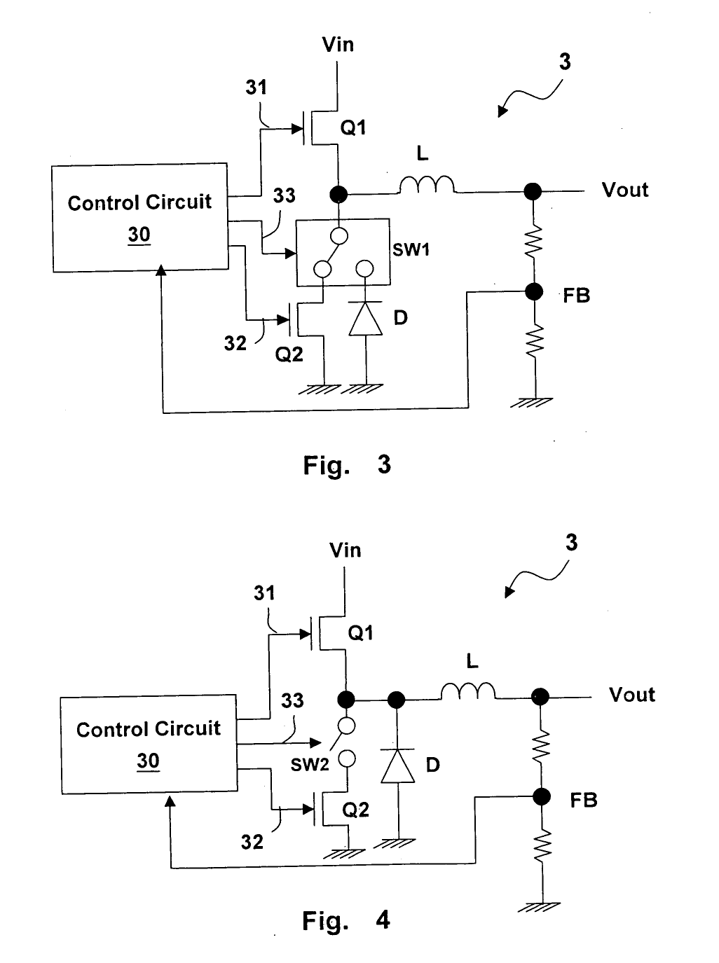

Referring to FIG. 3, the present invention combines the advantages of both synchronous and asynchronous buck switching regulators wherein the circuit operates in the synchronous mode in heavy load, and operates in the asynchronous mode in light or no load. As shown in the drawing, the dual-mode buck switching regulator 3 of the present invention comprises a first power transistor Q1 having an end coupled to an input voltage Vin and another end to a common node; an inductor L having an end coupled to the common node and another end coupled to an output voltage Vout; a second power transistor Q2 having an end coupled to ground; a diode D having an end coupled to ground; and a control circuit 30 generating switch control signals 31 and 32 to control operations of the power transistors Q1 and Q2 according to a feedback signal FB obtained from the output voltage Vout. In addition, the control circuit 30 further generates a mode selection signal 33, such that in the synchronous mode, another end of the second power transistor Q2 is coupled to the common node, while in the asynchronous mode, the other end of the diode D is coupled to the common node and the aforementioned other end of the second power transistor Q2 is not coupled to the common node.

In this embodiment, the switching between the synchronous mode and the asynchronous mode can be achieved by a switch circuit SW1; it determines whether the common node is coupled to the second power transistor Q2 or the diode D according to the mode selection signal 33 issued by the control circuit 30.

FIG. 4 shows another embodiment of the present invention. In this embodiment, the diode D is always connected with the common node. The mode selection signal 33 controls a switch circuit SW2, such that the second power transistor Q2 is coupled to the common node in the synchronous mode but is not coupled to the common node in the asynchronous mode. Although the diode D is always connected to the common node whereas the second power transistor Q2 is connected with the diode D in parallel in the synchronous mode, such connection does not affect the function of the circuit; this embodiment can achieve the same effect as the previous embodiment.

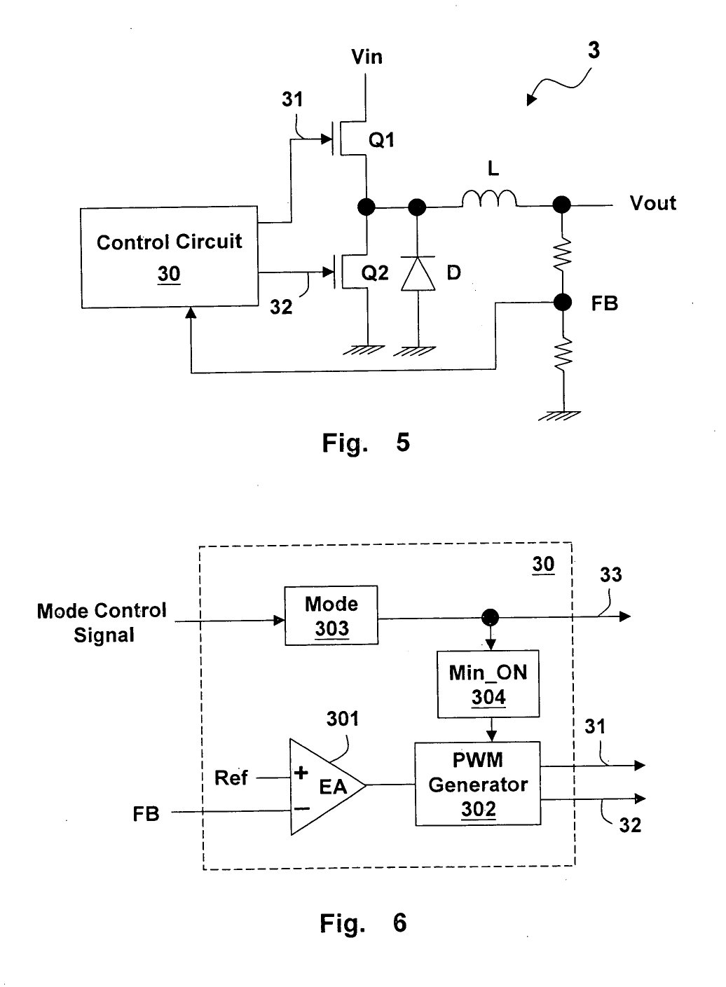

FIG. 5 shows another embodiment of the present invention. In this embodiment, the switch circuits SW1 and SW2 are omitted. The switch control signal 32 issued by the control circuit 30 controls the second power transistor Q2 and the first power transistor Q1 such that they switch synchronously in the synchronous mode, and that the second power transistor Q2 maintains off in the asynchronous mode. This embodiment can also achieve the same effect as the previous two embodiments.

FIG. 6 illustrates an example of the internal circuit structure of the control circuit 30. An error amplifier 301 compares a feedback signal FB with a reference signal Ref to generate an error amplified signal, which is sent to a PWM generator 302. The PWM generator 302 generates a first and a second PWM signals 31 and 32 according to the error amplified signal; in this embodiment, the first and second PWM signals 31 and 32 are the switch control signals 31 and 32. The control circuit 30 further includes a mode selection circuit (Mode) 303 which determines whether to switch to the synchronous mode or the asynchronous mode according to a mode control signal, and generates a corresponding mode selection signal 33. The mode control signal can be embodied by various ways; for example, it can be derived from a load circuit (a circuit receiving the output voltage Vout), or it can be generated according to an output current in the dual-mode buck switching regulator 3, or the like. Basically, any signal capable of indicating load conditions can be taken as the mode control signal.

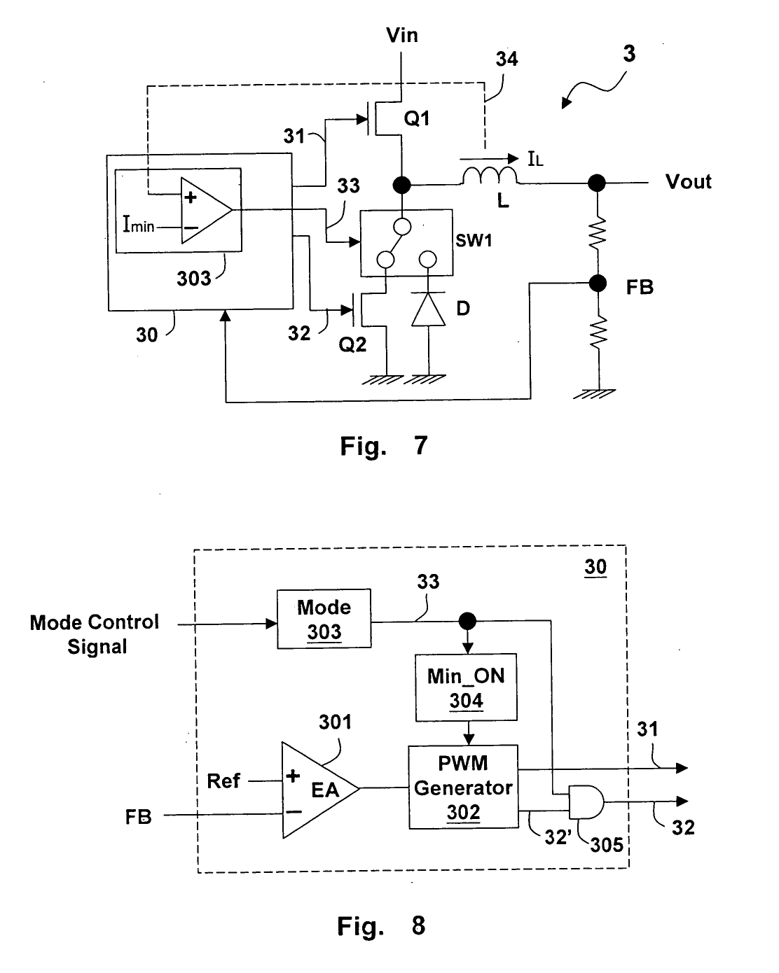

FIG. 7 illustrates by way of example how the mode selection circuit 303 generates the mode selection signal 33. As shown in the drawing, because the inductor current I_{L} corresponds to the output current (i.e., the current supplied to the load circuit), a signal 34 can be obtained by detecting the inductor current I_{L}, and the signal 34 is compared with a signal representing a predetermined minimum current Imin. When the inductor current I_{L} is lower than the reference signal Imin, the circuit switches to the asynchronous mode. Certainly, the mode control signal in FIG. 6 is not limited to the inductor current detection signal 34 in FIG. 7, but instead can be any signal capable of determining the load condition, such as a signal derived from the load circuit or the like, as described above.

Returning to FIG. 6, preferably but not necessarily, the control circuit 30 can further include a minimum on-time circuit (Min_ON) 304, which generates a minimum on-time when the mode selection signal 33 selects the asynchronous mode, such that the first power transistor Q1 operates according to the minimum on-time, that is, the first PWM signal 31 generated by the PWM generator controls the first power transistor Q1 such that the first power transistor Q1 has a conduction period not shorter than the minimum on-time. This can reduce the switching times of the first power transistor Q1, to thereby reduce the power consumption of the power regulator.

Referring to FIG. 8 in conjunction with FIG. 5, another embodiment of the control circuit 30 is shown. In this embodiment, it is not required for the control circuit 30 to output the mode selection signal 33. A logic gate 305 performs logic operation on the second PWM signal 32′ generated by the PWM generator 302 and the mode selection signal 33 to generate the second switch control signal 32. The logic gate 305 for example can be a simple AND gate (it can certainly be a more complicated circuit). When the mode selection signal 33 is low, the second switch control signal 32 maintains low level, and when the mode selection signal 33 is high, the second switch control signal 32 follows the second PWM signal 32′. Referring to FIG. 5 in conjunction with FIG. 8, it means that the second power transistor Q2 maintains off in the asynchronous mode, while its operation is controlled by the second PWM signal 32′ in the synchronous mode.

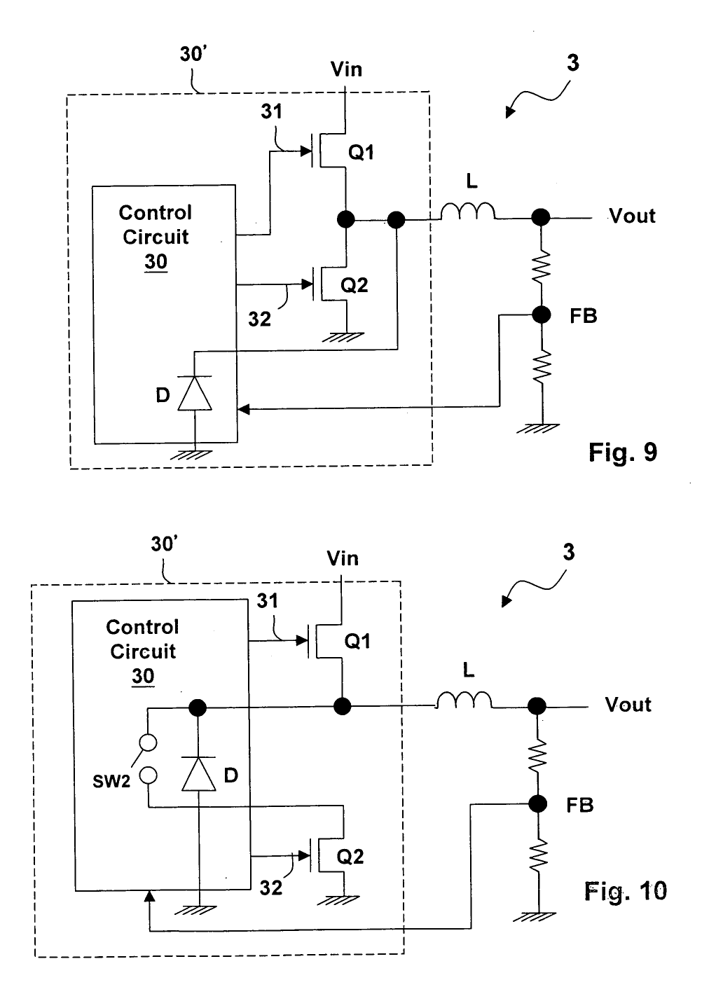

In the foregoing embodiments, the control circuit 30 is an integrated circuit; the switches SW1 and SW2, diode D, power transistors Q1 and Q2 are external discrete devices. However, as shown in FIGS. 9 and 10, the diode D and/or the switch SW2 (or the switch SW1, not shown) can be integrated into the integrated circuit (such as the control circuit 30 shown by the solid line), or even the power transistors Q1 and Q2 can be integrated into the integrated circuit (such as the control circuit 30′ shown by the dashed line).

The present invention has been described in considerable detail with reference to certain preferred embodiments thereof. It should be understood that the description is for illustrative purpose, not for limiting the scope of the present invention. Those skilled in this art can readily conceive variations and modifications within the spirit of the present invention. For example, the power transistors Q1 and Q2 can be PMOS or NMOS transistors; the positive and negative input terminals of the comparator can be interchanged; the definitions of high and low levels of each signal can be interchanged, etc. Such modifications only require minor changes of certain portions in the circuit. In view of the foregoing, the spirit of the present invention should cover all such and other modifications and variations, which should be interpreted to fall within the scope of the following claims and their equivalents.

What is claimed is:

1. A dual-mode buck switching regulator, comprising:
a first power transistor having an end coupled to an input voltage and another end coupled to a common node;
an inductor having an end coupled to the common node and another end coupled to the output voltage;
a second power transistor having an end coupled to ground;
a diode having an end coupled to ground; and
a control circuit generating a first and a second switch control signals for controlling operations of the first and the second power transistors according to a feedback signal, and generating a mode selection signal according to a mode control signal to select a synchronous or an asynchronous mode,
wherein the second power transistor has another end which is coupled to the common node in the synchronous mode, and
the diode has another end which is coupled to the common node in the asynchronous mode, and in the asynchronous mode:
(1) the another end of the second power transistor is not coupled to the common mode, or
(2) the second power transistor maintains off.

2. The dual-mode buck switching regulator of claim 1, further comprising a switch circuit selectively coupling the another end of the second power transistor or the another end of the diode to the common node according to the mode selection signal.

3. The dual-mode buck switching regulator of claim 1, wherein the another end of the diode is always coupled to the common node.

4. The dual-mode buck switching regulator of claim 3, further comprising a switch circuit selectively coupling the another end of the second power transistor to the common node according to the mode selection signal.

5. The dual-mode buck switching regulator of claim 1, wherein the control circuit includes:
an error amplifier comparing the feedback signal with a first reference signal to generate an error amplified signal;
a PWM generator generating a first and second PWM signals according to the error amplified signal; and
a mode selection circuit generating the mode selection signal according to the mode control signal.

6. The dual-mode buck switching regulator of claim 5, wherein the control circuit further includes:
a logic gate performing logic operation on the second PWM signal generated by the PWM generator and the mode selection signal to generate the second switch control signal, such that the second power transistor maintains off when the mode selection signal selects the asynchronous mode.

7. The dual-mode buck switching regulator of claim 5, wherein the control circuit further includes:
a minimum on-time circuit generating a minimum on-time when the mode selection signal selects the asynchronous mode, such that the first power transistor operates according to the minimum on-time.

8. The dual-mode buck switching regulator of claim 5, wherein the mode selection circuit includes a comparator comparing the mode control signal with a second reference signal to generate the mode selection signal.

9. A control circuit for a dual-mode buck switching regulator, comprising:
an error amplifier comparing a feedback signal with a first reference signal to generate an error amplified signal;
a PWM generator generating a first and a second PWM signals according to the error amplified signal; and
a mode selection circuit generating a mode selection signal according to a mode control signal to determine whether the dual-mode buck switching regulator enters a synchronous mode or an asynchronous mode.

10. The control circuit of claim 9, wherein the dual-mode buck switching regulator includes a first power transistor having an end coupled to an input voltage and another end coupled to a common node; an inductor having an end coupled to the common node and another end coupled to an output voltage; a second power transistor having an end coupled to ground; and a diode having an end coupled to ground; wherein the second power transistor has another end which is coupled to the common node in the synchronous mode, and the diode has another end which is coupled to the common node in the asynchronous mode, and in the asynchronous mode (1) the another end of the second power transistor is not coupled to the common node, or (2) the second power transistor maintains off.

11. The control circuit of claim 10, further comprising a switch circuit selectively coupling the another end of the second power transistor or the another end of the diode to the common node according to the mode selection signal.

12. The control circuit of claim 10, further comprising a switch circuit selectively coupling the another end of the second power transistor to the common node according to the mode selection signal.

13. The control circuit of claim 10, wherein the diode is integrated within the control circuit.

14. The control circuit of claim 10, wherein the first and second power transistors are integrated within the control circuit.

15. The control circuit of claim 9, further comprising: a logic gate performing logic operation on the second PWM signal generated by the PWM generator and the mode selection signal to generate an output signal, wherein the output signal maintains the same level under asynchronous mode and follows the second PWM signal under the synchronous mode.

16. The control circuit of claim 9, further comprising: a minimum on-time circuit generating a minimum on-time when the mode selection signal selects the asynchronous mode, such that the PWM generator generates the first PWM signal according to the minimum on-time.

17. The control circuit of claim 9, wherein the mode selection circuit includes a comparator comparing the mode control signal with a second reference signal to generate the mode selection signal.
